(19) United States
(12) Patent Application Publication
(10) Pub. No.: US 2020/0310518 A1
(43) Pub. Date: Oct. 1, 2020

(54) MANAGEMENT SYSTEM, MANAGEMENT METHOD, DISPLAY APPARATUS, AND MANAGEMENT APPARATUS

(71) Applicant: KYOCERA Corporation, Kyoto-shi, Kyoto (JP)

(72) Inventor: Yuji KAKUDA, Yokohama-shi, Kanagawa (JP)

(21) Appl. No.: 16/304,134

(22) PCT Filed: May 23, 2017
(86) PCT No.: PCT/JP2017/019106

§ 371 Date: Nov. 22, 2018

(30) Foreign Application Priority Data
May 24, 2016 (JP) 2016-103057

(51) Int. Cl. G06F 1/3209; G06F 1/3234

(52) U.S. Cl. CPC G06F 1/3209; G06F 1/3265

(57) ABSTRACT

A management system includes a management apparatus; a power conversion apparatus configured to convert, at least one of output power from a distributed power source and input power into the distributed power source, into AC power or DC power; and a display apparatus configured to display a state of the power conversion apparatus. The management apparatus includes a transmitter configured to transmit to the display apparatus, a transmission source message for specifying a transmission source of a power control message controlling the power conversion apparatus.

### RELATED APPLICATIONS

The present application is a national phase of International Application Number PCT/JP2017/019106, filed May 23, 2017, which claims priority to Japanese Application Number 2016-103057, filed May 24, 2016.

### TECHNICAL FIELD

The present invention relates to a management system, a management method, a display apparatus, and a management apparatus.

### BACKGROUND ART

In recent years, a management system having a power conversion apparatus configured to control distributed power sources and a management apparatus configured to perform communication with the power conversion apparatus has been proposed (for example, Patent Literature 1). The distributed power sources are power sources such as a solar battery, a rechargeable battery, and a fuel battery.

It is effective to standardize communication standards between the distributed power sources and the management apparatus in order to widely use the above management system, and the standardization of the communication standards have been attempted.

Further, the power conversion apparatus is configured to operate on the basis of a power control message designated by a business operator (such as electricity generation utility, electricity transmission/distribution utility, or electricity retailer).

### CITATION LIST

### Patent Literature

Patent Literature 1: JP 2014-171359 A

### SUMMARY

A first aspect is related to a management system comprising: a management apparatus; a power conversion apparatus configured to convert, at least one of output power from a distributed power source and input power into the distributed power source, into AC power or DC power; and a display apparatus configured to display a state of the power conversion apparatus. The management apparatus comprises a transmitter configured to transmit to the display apparatus, a transmission source message for specifying a transmission source of a power control message controlling the power conversion apparatus.

A second aspect is related to a management method used in a management system comprising a management apparatus, a power conversion apparatus configured to convert, at least one of output power from a distributed power source and input power into the distributed power source, into AC power or DC power, and a display apparatus configured to display a state of the power conversion apparatus. The method comprises transmitting from the management apparatus to the display apparatus, a transmission source message for specifying a transmission source of a power control message controlling the power conversion apparatus.

A third aspect is related to a display apparatus provided in a management system comprising a management apparatus, and a power conversion apparatus configured to convert, at least one of output power from a distributed power source and input power into the distributed power source, into AC power or DC power, and configured to display a state of the power conversion apparatus. The display apparatus comprises a receiver configured to receive a transmission source message for specifying a transmission source of a power control message controlling the power conversion apparatus from the management apparatus.

A fourth aspect is related to a management apparatus provided in a management system comprising a power conversion apparatus configured to convert, at least one of output power from a distributed power source and input power into the distributed power source, into AC power or DC power, and a display apparatus configured to display a state of the power conversion apparatus. The management apparatus comprises a transmitter configured to transmit, to the display apparatus, a transmission source message for specifying a transmission source of a power control message controlling the power conversion apparatus.

### BRIEF DESCRIPTION OF DRAWINGS

FIG. 1 is a diagram illustrating a management system 1 according to an embodiment.

FIG. 2 is a diagram illustrating a communication apparatus 132 according to the embodiment.

FIG. 3 is a diagram illustrating an EMS 160 according to the embodiment.

FIG. 4 is a diagram illustrating a display apparatus 170 according to the embodiment.

FIG. 5 is a diagram illustrating an exemplary SET command according to the embodiment.

FIG. 6 is a diagram illustrating an exemplary SET response command according to the embodiment.

FIG. 7 is a diagram illustrating an exemplary GET command according to the embodiment.

FIG. 8 is a diagram illustrating an exemplary GET response command according to the embodiment.

FIG. 9 is a diagram illustrating an exemplary INF command according to the embodiment.

FIG. 10 is a sequence diagram illustrating a management method according to the embodiment.

FIG. 11 is a sequence diagram illustrating the management method according to the embodiment.

FIG. 12 is a sequence diagram illustrating a management method according to a first modification.

### DESCRIPTION OF EMBODIMENTS

An embodiment will be described below with reference to the drawings. The same or similar parts are denoted with the same or similar reference numerals in the following description of the drawings.

However, the drawings are schematic, and the ratio and the like of each dimension may be different from actual ones. Thus, the specific dimensions and the like should be determined in consideration of the following description. Parts with mutually different dimension relationships or ratios are included in the drawings.

### Embodiment

(Management System)

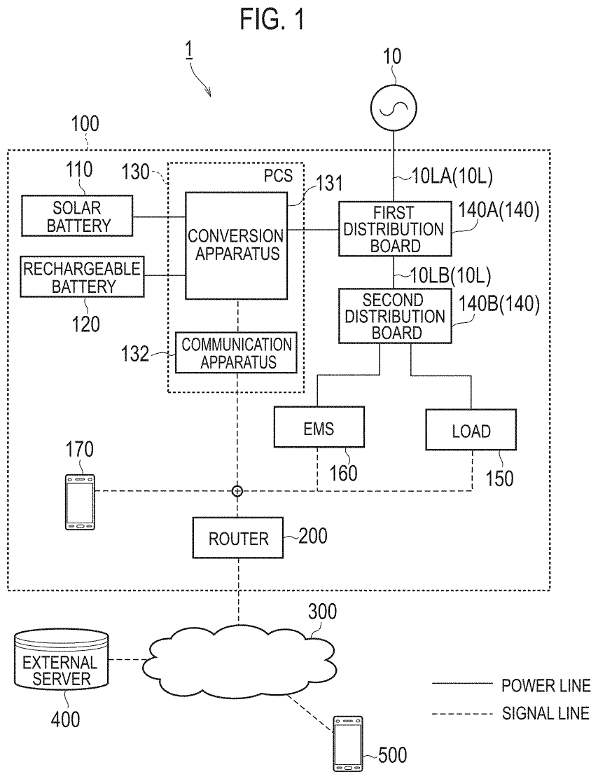

A management system according to an embodiment will be described below. As illustrated in FIG. 1, a management system 1 has a facility 100, an external server 400, and a user terminal 500. The facility 100 has a router 200. The router 200 is connected to the external server 400 via a network 300. The router 200 configures a local area network, and is connected to the respective apparatuses (such as a communication apparatus 132 in a PCS 130, a load 150, an EMS 160, and a display apparatus 170). In FIG. 1, a solid line indicates a power line and a dotted line indicates a signal line. However, it is not limited to the illustration, a signal may be transmitted on a power line.

The facility 100 has a solar battery 110, a rechargeable battery 120, the PCS 130, distribution boards 140, the load 150, the EMS 160, and the display apparatus 170.

The solar battery 110 is an apparatus configured to generate power in response to a received light. The solar battery 110 outputs generated DC power. The amount of power generated in the solar battery 110 changes depending on the amount of solar radiation on the solar battery 110. According to the embodiment, the solar battery 110 is an exemplary distributed power source, output of which is capable of being restricted on the basis of an output suppression designated by a business operator, but it is not limited thereto, and the rechargeable battery 120 may be a distributed power source, output of which is capable of being restricted on the basis of an output suppression designated by a business operator.

The rechargeable battery 120 is an apparatus configured to accumulate power. The rechargeable battery 120 outputs accumulated DC power. According to the embodiment, the rechargeable battery 120 will be described as an exemplary distributed power source, output of which is not capable of being restricted on the basis of an output suppression designated by a business operator, but is not limited thereto and may be a distributed power source, output of which is capable of being restricted.

The PCS 130 is an example of power conversion apparatus (PCS: Power Conditioning System) configured to convert, at least one output power from a distributed power source and input power, into the distributed power source into AC power or DC power. According to the embodiment, the PCS 130 has a conversion apparatus 131 and the communication apparatus 132. According to the embodiment, the PCS 130 is an exemplary unit including the conversion apparatus 131.

The conversion apparatus 131 converts DC power from the solar battery 110 into AC power, and converts DC power from the rechargeable battery 120 into AC power. Further, the conversion apparatus 131 converts AC power from a power system 10 into DC power. The conversion apparatus 131 is connected to a main power line 10L (a main power line 10LA and a main power line 10LB herein) connected to the power system 10 via a first distribution board 140A, and is connected to both the solar battery 110 and the rechargeable battery 120. The main power line 10LA is a power line connecting the power system 10 and the first distribution board 140A, and the main power line 10LB is a power line connecting the first distribution board 140A and a second distribution board 140B. Additionally, a hybrid power conversion apparatus in which the conversion apparatus 131 is connected to the solar battery 110 and the rechargeable battery 120 will be described according to the present embodiment, but there may be configured such that power conversion apparatuses are connected to the solar battery 110 and the rechargeable battery 120, respectively. If there is configured such that power conversion apparatuses are connected to the solar battery 110 and the rechargeable battery 120, respectively, the respective power conversion apparatus can control similarly to the hybrid power conversion apparatus according to the present embodiment.

The communication apparatus 132 is connected to the conversion apparatus 131, receives various messages to the conversion apparatus 131, and transmits various messages from the conversion apparatus 131. Communication between the communication apparatus 132 and the conversion apparatus 131 uses a protocol (such as unique protocol) applied to the PCS 130.

According to the embodiment, the communication apparatus 132 is connected to the router 200 in a wired or radio manner. The communication apparatus 132 is connected to the external server 400 via the router 200, and receives an output suppression message for instructions to restrict an output of a distributed power source from the external server 400. Second, the communication apparatus 132 is connected to the EMS 160 via the router 200, and performs communication for predetermined commands in a predetermined format with the EMS 160. The predetermined format is not particularly limited, and may employ the ECHONET system, the ECHONET Lite system, the SEP2.0 system, the KNX system, or the like, for example.

The predetermined format will be described as a format conforming to the ECHONET Lite system, for example. In such a case, the predetermined commands can be largely divided into request commands, request response commands as responses to request commands, and information notification commands, for example. The request commands are a SET command, a GET command, and the like, for example. The request response commands are a SET response command as a response to a SET command, a GET response command as a response to a GET command, and the like, for example. The information notification commands are an INF command and the like, for example.

The SET command is a command including a property for instructions to set or operate the PCS 130. The SET response command is a command indicating that the SET command is received. The GET command is a command including a property indicating a state of the PCS 130, and for acquiring the state of the PCS 130. The GET response command is a command including a property indicating a state of the PCS 130, and including information requested in the GET command. The INF command is a command including a property indicating a state of the PCS 130, and for notifying the state of the PCS 130.

The distribution boards 140 are connected to the main power line 10L. The distribution boards 140 have the first distribution board 140A and the second distribution board 140B. The first distribution board 140A is connected to the power system 10 via the main power line 10LA, and is connected to the solar battery 110 and the rechargeable battery 120 via the conversion apparatus 131. Further, the first distribution board 140A controls power output from the conversion apparatus 131 and power supplied from the power system 10 and flows the power to the main power line 10LB. The power flowing from the main power line 10LB is distributed into the respective devices (the load 150 and the EMS 160 herein) via the second distribution board 140B.

The load 150 is an apparatus which consumes the power supplied via the power line. For example, the load 150 includes apparatuses such as an air conditioner, an illumination apparatus, a refrigerator, and a TV. The load 150 may be a single apparatus, and may include a plurality of apparatuses.

The EMS 160 is an energy management system (EMS) configured to manage power information indicating power in the facility 100. The power in the facility 100 indicates power flowing in the facility 100, power purchased by the facility 100, power sold by the facility 100, or the like. Thus, the EMS 160 manages at least the PCS 130, for example.

The EMS 160 may control the amount of power generated in the solar battery 110, the amount of power charged in the rechargeable battery 120, and the amount of power discharged in the rechargeable battery 120. The EMS 160 may be configured to be integral with the distribution boards 140. The EMS 160 is an apparatus connected to the network 300, and the functions of the EMS 160 may be provided by a Cloud service via the network 300.

According to the embodiment, the EMS 160 is connected to the respective devices (such as the communication apparatus 132 in the PCS 130, and the load 150) via the router 200, and performs communication for predetermined commands in a predetermined format with the respective devices.

The EMS 160 is connected to the display apparatus 170 via the router 200, and performs communication with the display apparatus 170. The EMS 160 may communicate predetermined commands in a predetermined format with the display apparatus 170. As described above, the predetermined format conforms to the ECHONET Lite system, for example.

The display apparatus 170 displays a state of the PCS 130. The display apparatus 170 may display the power information indicating the power in the facility 100. The display apparatus 170 is a smartphone, a tablet computer, a TV, a personal computer, or a dedicated terminal, for example. The display apparatus 170 is connected to the EMS 160 in a wired or radio manner, and performs communication with the EMS 160. The display apparatus 170 may communicate predetermined commands in a predetermined format with the EMS 160. The display apparatus 170 receives data required to display various items of information from the EMS 160.

The network 300 is a communication network for connecting the EMS 160 and the external server 400. The network 300 may be a public communication line such as Internet. The network 300 may include a mobile communication network. Further, the network 300 may be a dedicated communication line or a general communication line. For example, if an output of the solar battery 110 is a predetermined output or more, the output can be restricted by use of a dedicated communication line for the network 300 with higher accuracy.

The external server 400 is managed by a business operator such as electricity generation utility, electricity transmission/distribution utility, or electricity retailer. For example, the business operator designates an output suppression of the distributed power sources, and is an electricity generation utility, an electricity transmission/distribution utility, an electricity retailer, or a distributed power sources' collective manager. Specifically, the external server 400 transmits an output suppression message for instructions to restrict an output of a distributed power source. The external server 400 may transmit a power flow restriction message (demand response (DR)) for instructions to restrict a power flow from the power system 10 to the facility 100.

The output suppression message includes a target output suppression level indicating an output suppression level of a distributed power source (the solar battery 110 herein). The target output suppression level is defined depending on an output (denoted as facility recognized output) which is recognized as an output capability (such as rated output) of the PCS configured to control the distributed power sources. The target output suppression level may be indicated by an absolute value (such as ∘∘ kW) defined depending on the facility recognized output, may be indicated by a relative value (such as reduction by ∘∘ kW) relative to the facility recognized output, and may be indicated by a restriction rate (such as ∘∘%) relative to the facility recognized output. Additionally, as described for the facility recognized output, the facility recognized capacity [kWh] may be employed. Further, the distributed power sources may be the rechargeable battery 120 and a fuel battery.

If the output capability of a distributed power source is different from the output capability of the PCS, the facility recognized output is set at the lower output capability out of the output capabilities. If a plurality of PCSs are installed, the facility recognized output is a total of the output capabilities of the PCSs.

According to the embodiment, the output suppression message includes calendar information indicating a schedule of the output suppression of a distributed power source. In the calendar information, the schedule of the output suppression of a distributed power source may be set per 30 minutes. The calendar information may include a schedule of one day, may include a schedule of one month, or may include a schedule of one year.

According to the embodiment, a predetermined period may be defined as a maximum period in which output of a distributed power source is restricted. The predetermined period may be days per year (day-based rule), or an accumulated time per year (accumulated time-based rule). More specifically, the predetermined period may be 30 days per year (30-day-based rule), or may be 360 hours per year (360-hour-based rule). However, the predetermined period may not be defined (designated rule). The rules are types of the output suppression of a distributed power source according to the output suppression message.

According to the embodiment, the external server 400 transmits a power control message for controlling the conversion apparatus 131 to the PCS 130 via the EMS 160. The power control message may be a message for controlling the conversion apparatus 131, may be a message for instructions to increase or decrease an output of the solar battery 110, or may be a message for instructions to accumulate power in or discharge the rechargeable battery 120. Further, the power control message may be an output suppression message and a power flow restriction message, but the output suppression message or the power flow restriction message may be transmitted from the external server 400 to the PCS 130 not via the EMS 160.

The user terminal 500 transmits a power control message for controlling the conversion apparatus 131 via the EMS 160. The user terminal 500 is a smartphone, a tablet computer, or a dedicated terminal, for example. The user terminal 500 may be owned by a user using the solar battery 110, the rechargeable battery 120, or the PCS 130, or may be owned by a business operator in charge of maintenance of the solar battery 110, the rechargeable battery 120, or the PCS 130. The power control message may be a message for controlling the conversion apparatus 131, may be a message for instructions to increase or decrease an output of the solar battery 110, or may be a message for instructions to accumulate power in or discharge the rechargeable battery 120.

In FIG. 1, the user terminal 500 is connected to the EMS 160 via the network 300 and the router 200, but the embodiment is not limited thereto. The user terminal 500 is positioned in the customer's facility 1, and may be connected to the EMS 160 via the router 200 not via the network 300. For example, the user terminal 500 may be the display apparatus 170 described above. Additionally, the user terminal 500 may be connected to the EMS 160 via the network 300 and the router 200.

(Application Scenes)

As described above, a power control message may be transmitted from the external server 400, and may be transmitted from the user terminal 500. Thus, it is assumed that a power control message transmitted from the external server 400 and a power control message transmitted from the user terminal 500 compete with each other. In such a case, if it is not possible to grasp according to whose instruction the conversion apparatus 131 operates, the conversion apparatus 131 cannot be appropriately controlled.

In terms of such a viewpoint, according to the embodiment, the EMS 160 transmits a transmission source message for specifying a transmission source of a power control message to the display apparatus 170. The transmission source may be selected from the business operator managing the power system to which the conversion apparatus 131 is connected, and the user operating the conversion apparatus 131. The business operator managing the power system to which the conversion apparatus 131 is connected manages the external server 400, and is a business operator such as an electricity generation utility, an electricity transmission/distribution utility, an electricity retailer, or a distributed power sources' collective manager. The user operating the conversion apparatus 131 manages the user terminal 500, may use the solar battery 110, the rechargeable battery 120, or the PCS 130, for example, and may be in charge of maintenance of the solar battery 110, the rechargeable battery 120, or the PCS 130.

The display apparatus 170 described above displays information specifying a transmission source in reception of a transmission source message. For example, the information specifying a transmission source is “running under control of business operator such as electricity generation utility,” “running under user's control,” and the like. The information specifying a transmission source does not necessarily need to include the name of a transmission source, and may be information indicating “under centralized control” or “individual running.”

Further, communication information indicating a communication path via which a power control message is sent may be included together with the information specifying a transmission source. The communication information may be an information element indicating whether a power control message is routed via a public line (operation via public line), or an information element indicating whether a power control message is routed via a dedicated line (operation via dedicated line).

(Communication Apparatus)

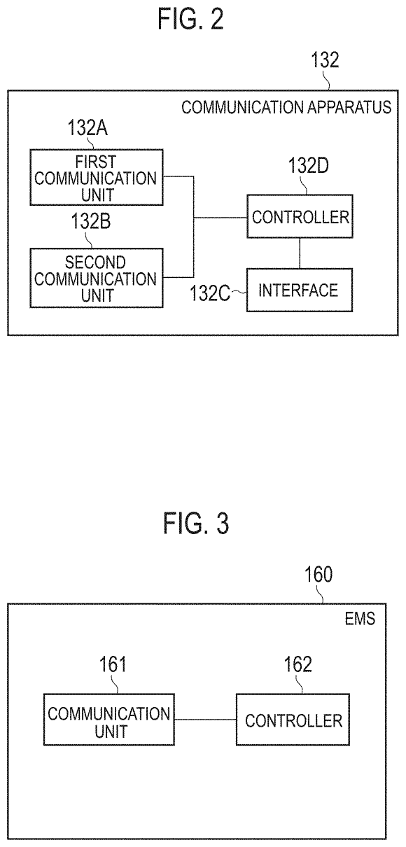

The communication apparatus according to the embodiment will be described below. As illustrated in FIG. 2, the communication apparatus 132 has a first communication unit 132A, a second communication unit 132B, an interface 132C, and a controller 132D. The communication apparatus 132 (or the PCS 130) is an exemplary device herein.

The first communication unit 132A receives an output suppression message or a power flow restriction message from the external server 400. According to the embodiment, the first communication unit 132A may receive an output suppression message or a power flow restriction message not via the EMS 160, and may receive an output suppression message or a power flow restriction message via the EMS 160.

The second communication unit 132B performs communication for predetermined commands in a predetermined format with the EMS 160. As described above, the predetermined format conforms to the ECHONET Lite system, for example. Here, the predetermined format used for communication between the communication apparatus 132 (the second communication unit 132B) and the EMS 160 may be different from the format used for communication between the communication apparatus 132 (the first communication unit 132A) and the external server 400. Further, the predetermined format used for communication between the communication apparatus 132 (the second communication unit 132B) and the EMS 160 may be different from the format used for communication between the communication apparatus 132 (the interface 132C) and the conversion apparatus 131.

The interface 132C is an interface for the conversion apparatus 131. The interface 132C may be a wired interface and may be a radio interface. A protocol (such as unique protocol) applied to the PCS 130 is used for communication between the communication apparatus 132 and the conversion apparatus 131.

The controller 132D is configured of a memory and a CPU, and controls the communication apparatus 132. For example, the controller 132D controls the conversion apparatus 131 by use of the interface 132C thereby to control an output of a distributed power source according to an output suppression message. The controller 132D acquires a state of the conversion apparatus 131 (such as the amount of power generated in the solar battery 110, the amount of power accumulated in the rechargeable battery 120, or the amount of power discharged in the rechargeable battery 120) from the conversion apparatus 131 by use of the interface 132C. The controller 132D generates a command to control the conversion apparatus 131 on the basis of a command received from the EMS 160, and outputs the command to the conversion apparatus 131 by use of the interface 132C.

(Management Apparatus)

The management apparatus according to the embodiment will be described below. As illustrated in FIG. 3, the EMS 160 has a communication unit 161 and a controller 162.

The communication unit 161 performs communication for predetermined commands in a predetermined format with the communication apparatus 132 and the display apparatus 170. As described above, the predetermined format conforms to the ECHONET Lite system, for example.

The controller 162 is configured of a memory and a CPU, and controls the EMS 160. The controller 162 may control the amount of power generated in the solar battery 110, the amount of power charged in the rechargeable battery 120, and the amount of power discharged in the rechargeable battery 120.

(Display Apparatus)

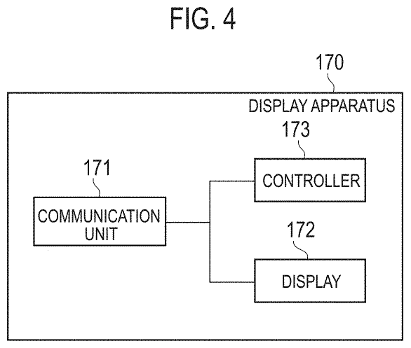

The display apparatus according to the embodiment will be described below. As illustrated in FIG. 4, the display apparatus 170 has a communication unit 171, a display 172, and a controller 173.

The communication unit 171 performs communication for predetermined commands in a predetermined format with the EMS 160. As described above, the predetermined format conforms to the ECHONET Lite system, for example.

The display 172 displays various items of information. The display 172 is an organic EL or liquid crystal display, for example. The display 172 displays the information specifying a transmission source, for example.

The controller 173 is configured of a memory and a CPU, and controls the display apparatus 170. The controller 173 controls display of the information specifying a transmission source in reception of a transmission source message, for example.

(Message Format)

The message format according to the embodiment will be described below. There will be described herein a case where the predetermined format conforms to the ECHONET Lite system.

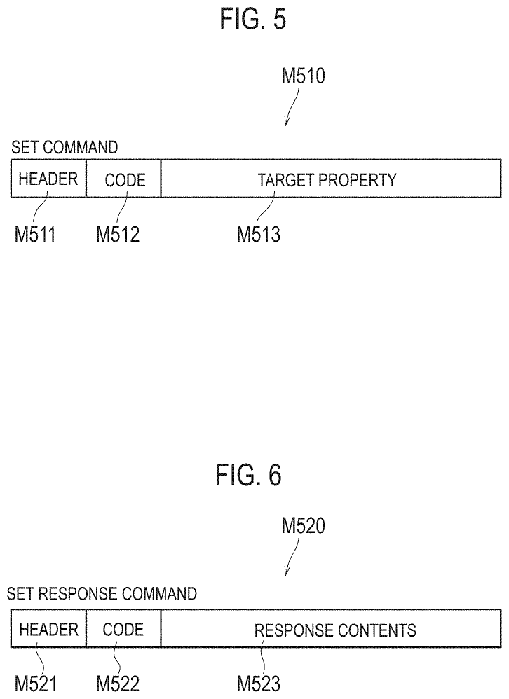

As illustrated in FIG. 5, a SET command M510 includes a header M511, a code M512, and a target property M513. According to the embodiment, the SET command M510 is an exemplary command for instructions to operate the PCS 130 in response to a power control message, and is transmitted from the EMS 160 to the PCS 130. That is, the SET command M510 may be considered as an exemplary power control message.

The header M511 is information indicating a destination and the like of the SET command M510. The code M512 is information indicating a type of a message including the code M512. The code M512 is information indicating that the message including the code M512 is a SET command herein. The target property M513 includes a property indicating an operation corresponding to instructions to the PCS 130 by the EMS 160.

As illustrated in FIG. 6, a SET response command M520 includes a header M521, a code M522, and response contents M523. According to the embodiment, the SET response command M520 is an exemplary command transmitted from the PCS 130 to the EMS 160 in response to a command received from the EMS 160.

The header M521 is information indicating a destination and the like of the SET response command M520. The code M522 is information indicating a type of a message including the code M522. The code M522 is information indicating that the message including the code M522 is a SET response command herein. The response contents M523 include information indicating that the SET command is received. The information may be a copied property included in the SET command, or may be acknowledgement (ACK). Further, the information is not limited thereto, and may be a response (selective ACK) indicating that only part of data is correctly received.

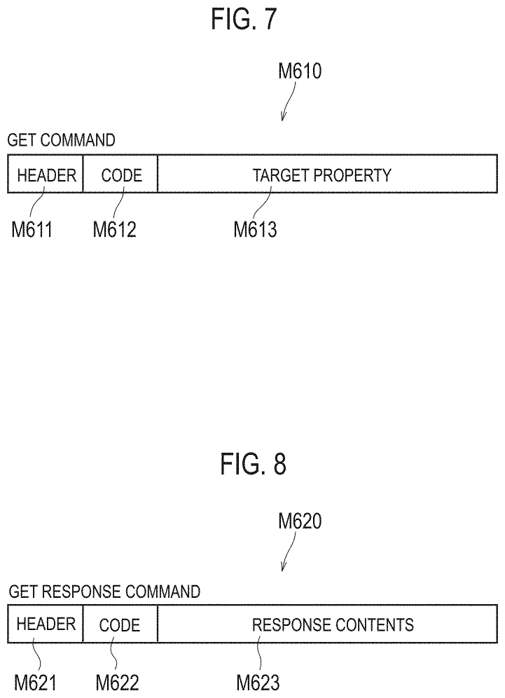

As illustrated in FIG. 7, a GET command M610 includes a header M611, a code M612, and a target property M613. According to the embodiment, the GET command M610 is an exemplary command to request a state of the PCS 130, and is an exemplary command transmitted from the EMS 160 to the PCS 130.

The header M611 is information indicating a destination and the like of the GET command M610. The code M612 is information indicating a type of a message including the code M612. The code M612 is information indicating that the message including the code M612 is a GET command herein. The target property M613 includes a property which the EMS 160 wants to know.

As illustrated in FIG. 8, a GET response command M620 includes a header M621, a code M622, and response contents M623. According to the embodiment, the GET response command M620 is an exemplary command transmitted from the PCS 130 to the EMS 160 in response to a command received from the EMS 160.

The header M621 is information indicating a destination and the like of the GET response command M620. The code M622 is information indicating a type of a message including the code M622. The code M622 is information indicating that the message including the code M622 is a GET response command herein. The response contents M623 include a property requested by the GET command.

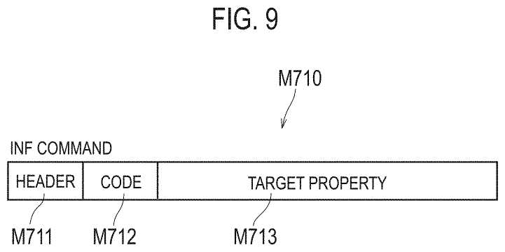

As illustrated in FIG. 9, an INF command M710 includes a header M711, a code M712, and a target property M713. According to the embodiment, the INF command M710 is an exemplary command to notify a transmission source to the display apparatus 170, and an exemplary transmission source message transmitted from the EMS 160 to the display apparatus 170.

The header M711 is information indicating a destination and the like of the INF command M710. The code M712 is information indicating a type of a message including the code M712. The code M712 is information indicating that the message including the code M712 is an INF command herein. The target property M713 includes a property notified by the EMS 160.

(Management Method)

A management method according to the embodiment will be described below. There will be described herein a case where a predetermined format used for communication between the PCS 130 (the communication apparatus 132) and the EMS 160 conforms to the ECHONET Lite system.

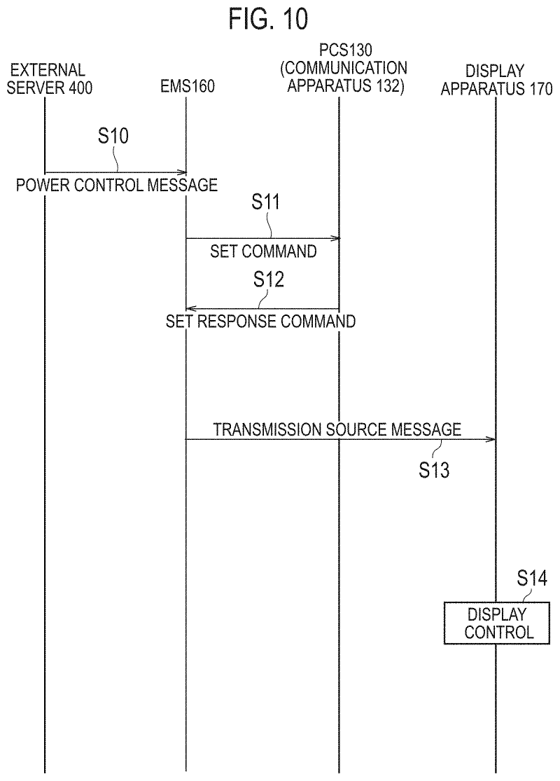

First, a case where a power control message is transmitted from the external server 400 will be first described with reference to FIG. 10.

As illustrated in FIG. 10, in step S10, the external server 400 transmits a power control message for controlling the conversion apparatus 131 to the EMS 160.

In step S11, the EMS 160 transmits a SET command corresponding to the power control message to the PCS 130.

In step S12, the PCS 130 transmits a SET response command to the SET command to the EMS 160.

In step S13, the EMS 160 transmits a transmission source message for specifying the transmission source of the power control message to the display apparatus 170. The transmission source message can use an INF command described above, a GET response to a GET command from the EMS 160, or the like, for example.

In step S14, the display apparatus 170 displays the information specifying a transmission source (business operator managing the external server 400 herein).

FIG. 10 illustrates a case where a SET command corresponding to a power control message is transmitted to the PCS 130. However, the embodiment is not limited thereto. If the power control message is an output suppression message or a power flow restriction message, the EMS 160 may transmit the output suppression message or the power flow restriction message to the PCS 130 instead of the processings in step S11 and step S12.

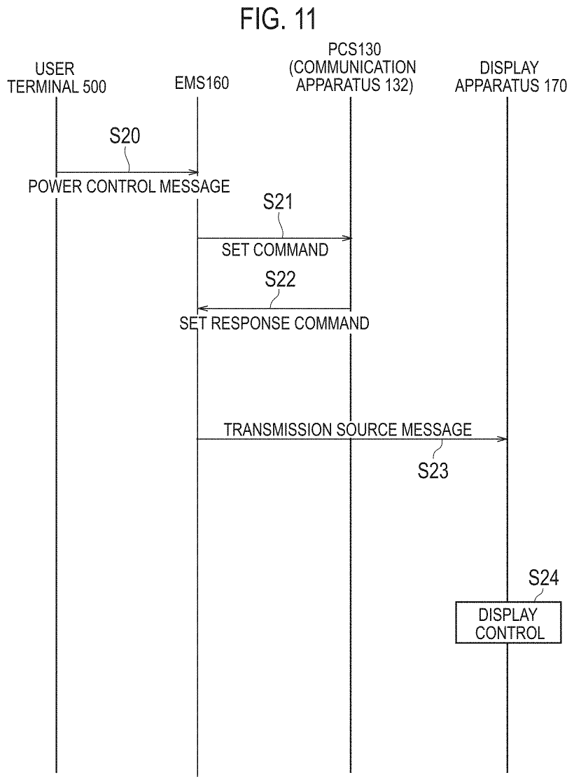

Second, a case where a power control message is transmitted from the user terminal 500 will be then described with reference to FIG. 11.

As illustrated in FIG. 11, in step S20, the user terminal 500 transmits a power control message for controlling the conversion apparatus 131 to the EMS 160.

In step S21, the EMS 160 transmits a SET command corresponding to the power control message to the PCS 130.

In step S22, the PCS 130 transmits a SET response command to the SET command to the EMS 160.

In step S23, the EMS 160 transmits the transmission source message for specifying the designation source of the power control message to the display apparatus 170. The transmission source message is an INF command described above, for example.

In step S24, the display apparatus 170 displays the information specifying a transmission source (business operator managing the user terminal 500 herein).

(Operations and Effects)

According to the embodiment, the EMS 160 transmits a designation source message for specifying a designation source of a power control message to the display apparatus 170. Thus, even if it is assumed that a power control message transmitted from the external server 400 and a power control message transmitted from the user terminal 500 compete with each other, it is possible to grasp that according to whose instructions the conversion apparatus 131 operates, and to appropriately control the conversion apparatus 131.

[First Modification]

A first modification of the embodiment will be described below.

The first modification will describe a case where a power control message transmitted from the external server 400 and a power control message transmitted from the user terminal 500 compete with each other. In such a case, the EMS 160 suspends transmission of a user-designated power control message while the conversion apparatus 131 is operating on the basis of a power control message designated by the business operator.

When the transmission source is a business operator, the display apparatus 170 displays that reception of a user-designated power control message is suspended while the conversion apparatus 131 is operating on the basis of a power control message designated by the business operator.

Transmission of the power control message may be suspended for a certain period of time, or may be suspended until the number of times of suspending exceeds the predetermined number of times. The number of times of suspending may be at least once, for example, or the number of times of suspending may be changed depending on a condition. If the number of times of suspending is changed depending on a condition, the user terminal may be configured such that the user terminal 500 suspends transmission of a power control message transmitted from the display apparatus 170 or a remote controller at least once, for example.

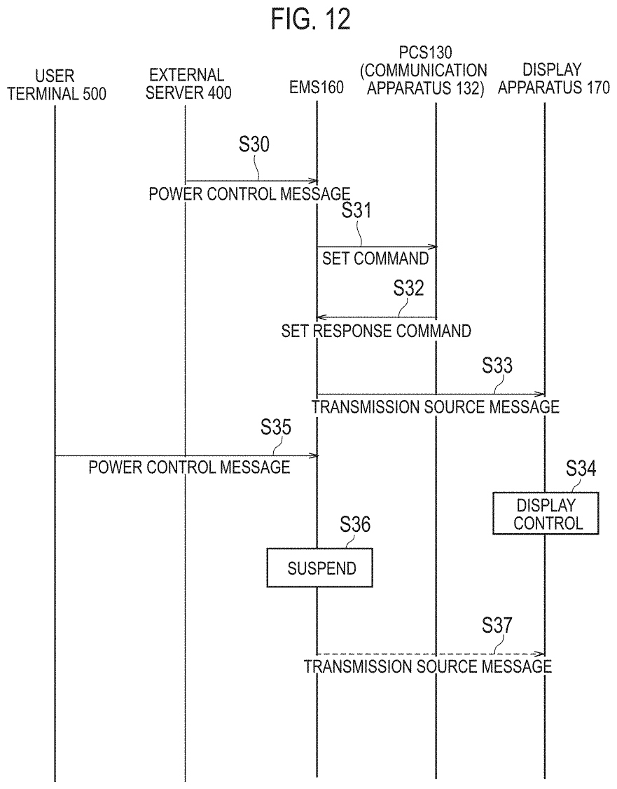

Specifically, as illustrated in FIG. 12, in step S30, the external server 400 transmits a power control message for controlling the conversion apparatus 131 to the EMS 160.

In step S31, the EMS 160 transmits a SET command corresponding to the power control message to the PCS 130.

In step S32, the PCS 130 transmits a SET response command to the SET command to the EMS 160.

In step S33, the EMS 160 transmits a transmission source message for specifying the designation source of the power control message to the display apparatus 170. The transmission source message is an INF command described above, for example.

In step S34, the display apparatus 170 displays the information specifying a transmission source (here, the business operator managing the external server 400). The display apparatus 170 displays that reception of the power control message received from the user terminal 500 is suspended. For example, the display apparatus 170 displays “reception of user control is not possible.”

In step S35, the user terminal 500 transmits a power control message for controlling the conversion apparatus 131 to the EMS 160.

In step S36, the EMS 160 suspends transmission of the power control message received from the user terminal 500.

In step S37, the EMS 160 may transmit a designation source message for specifying the designation source of the power control message to the display apparatus 170. The transmission source message is an INF command described above, for example. In such a case, the display apparatus 170 may display that the power control message is received from the user terminal 500. Further, the display apparatus 170 may display that reception of the power control message received from the user terminal 500 is suspended. For example, the display apparatus 170 displays “user control is suspended.”

FIG. 12 illustrates a case where a SET command corresponding to a power control message is transmitted to the PCS 130. However, the embodiment is not limited thereto. If the power control message is an output suppression message or a power flow restriction message, the EMS 160 may transmit the output suppression message or the power flow restriction message to the PCS 130 instead of the processings in step S31 and step S32.

### OTHER EMBODIMENT

The present invention has been described by way of the above embodiment, but the description and the drawings as part of the disclosure should not be considered as limiting the present invention. Various alternative embodiments, examples, and operation techniques will be apparent to those skilled in the art on the basis of the disclosure.

The embodiment has been described assuming that the predetermined format used for communication between the communication apparatus 132 and the EMS 160 conforms to the ECHONET Lite system. However, the embodiment is not limited thereto. The predetermined format may be any format standardized to be used in the facility 100.

The PCS 130 (multi-PCS) for controlling the solar battery 110 and the output of the rechargeable battery 120 has been described according to the embodiment by way of example. However, the embodiment is not limited thereto. The PCS 130 may be directed to controlling the solar battery 110 and may be directed to controlling the output of the rechargeable battery 120.

According to the embodiment, the display apparatus 170 is a smartphone, a tablet computer, a TV, or a dedicated terminal, for example. However, the embodiment is not limited thereto. The display apparatus 170 may be a remote controller configured to operate the conversion apparatus 131. The remote controller may be assumed as part of the PCS 130.

According to the embodiment, the communication apparatus 132 receives a SET command as an exemplary power control message from the EMS 160. However, the embodiment is not limited thereto. The EMS 160 may transmit a SET command as an exemplary power control message to the remote controller configured to operate the conversion apparatus 131. The remote controller may be assumed as the communication apparatus 132.

According to the embodiment, a power control message received from the external server 400 or the user terminal 500 is transmitted from the EMS 160 to the PCS 130 in the form of a SET command. The EMS 160 may appropriately convert the power control message received from the external server 400 or the user terminal 500, and may then transmit the converted power control message (the SET command, for example) to the PCS 130. The converted power control message is also an exemplary power control message for controlling the conversion apparatus 131. In such a case, the EMS 160 may transmit a plurality of SET commands to the PCS 130 at appropriate timings in order to control the PCS 130 on the basis of the power control message received from the external server 400 or the user terminal 500.

According to the embodiment, a power control message (such as an output suppression message or a power flow restriction message) can be transmitted to the PCS 130 not via the EMS 160. In such a case, the EMS 160 may receive the information specifying the transmission source of the power control message from the PCS 130. The PCS 130 may transmit the information specifying the transmission source of the power control message in an INF command to the EMS 160. The PCS 130 may transmit the information specifying the transmission source of the power control message in an INF command to the display apparatus 170.

The embodiment has been described assuming that the first communication unit 132A and the second communication unit 132B are in different configurations, but the first communication unit 132A and the second communication unit 132B may be integrated. That is, the first communication unit 132A may serve as the second communication unit 132B.

Though not particularly limited in the embodiment, the rechargeable battery 120 as an exemplary distributed power source may be provided in the facility 100, and may be provided in an electric vehicle (EV).

Additionally, the entire contents of Japanese Patent Application No. 2016-103057 (filed on May 24, 2016) are incorporated in the present specification by its reference.

1. A management system comprising:
a power conversion apparatus configured to convert, at least one of output power from a distributed power source and input power into the distributed power source, into AC power or DC power;
a display apparatus configured to display a state of the power conversion apparatus, and
a management apparatus, the management apparatus comprising a transmitter configured to transmit a transmission source message for specifying a transmission source of a power control message controlling the power conversion apparatus to the display apparatus.

2. The management system according to claim 1, wherein
the transmitter is further configured to transmit the power control message to a unit including the power conversion apparatus.

3. The management system according to claim 1, wherein
the transmission source includes a transmission source selected from a business operator managing a power system to which the power conversion apparatus is connected, and a user operating the power conversion apparatus.

4. The management system according to claim 1, wherein
the display apparatus is further configured to display information specifying the transmission source.

5. The management system according to claim 3, wherein
the management apparatus is further configured to suspend transmission of the power control message receive from the user operating the power conversion apparatus while the power conversion apparatus is operating on the basis of the power control message received from the business operator managing the power system.

6. The management system according to claim 1, wherein
the display apparatus is further configured to display that reception of the power control message received from a user operating the power conversion apparatus is suspended while the power conversion apparatus is operating on the basis of the power control message received from a business operator managing the power system when the transmission source is the business operator.

7. The management system according to claim 2, wherein
the display apparatus is a remote controller configured to operate the power conversion apparatus.

8. The management system according to claim 7, wherein
the unit further comprises the remote controller, and
the transmitter is further configured to transmit the power control message to the remote controller.

9. The management system according to claim 1, wherein
the display apparatus is a user terminal.

10. A management method used in a management system comprising a management apparatus, a power conversion apparatus configured to convert, at least one of output power from a distributed power source and input power into the distributed power source, into AC power or DC power, and a display apparatus configured to display a state of the power conversion apparatus, the method comprising:
transmitting from the management apparatus to the display apparatus, a transmission source message for specifying a transmission source of a power control message controlling the power conversion apparatus.

11. A display apparatus provided in a management system comprising a management apparatus, and a power conversion apparatus configured to convert, at least one of output power from a distributed power source and input power into the distributed power source, into AC power or DC power, and configured to display a state of the power conversion apparatus, the display apparatus comprising:
a receiver configured to receive a transmission source message for specifying a transmission source of a power control message controlling the power conversion apparatus from the management apparatus; and
a display.

12. A management apparatus provided in a management system comprising a power conversion apparatus configured to convert, at least one of output power from a distributed power source and input power into the distributed power source, into AC power or DC power, and a display apparatus configured to display a state of the power conversion apparatus, the management apparatus comprising:
a controller; and
a transmitter configured to transmit, to the display apparatus, a transmission source message for specifying a transmission source of a power control message controlling the power conversion apparatus.
